(19) United States
(12) Patent Application Publication
(10) Pub. No.: US 2024/0273565 A1
(43) Pub. Date: Aug. 15, 2024

(54) INFORMATION EQUIPMENT AND DISPLAY METHOD

(71) Applicant: TOYOTA JIDOSHA KABUSHIKI KAISHA, Toyota-shi (JP)

(72) Inventors: Kanako AIDA, Inuyama-shi (JP); Sayumi MIYAZAKI, Inazawa-shi (JP); Izumi SUGIYAMA, Nagoya-shi (JP); Koki KAWAMURA, Nagoya-shi (JP); Yohei KOIKE, Nagoya-shi (JP); Koji NISHI, Nagoya-shi (JP); Atsushi SAJIKI, Okazaki-shi (JP)

(73) Assignee: TOYOTA JIDOSHA KABUSHIKI KAISHA, Toyota-shi (JP)

(21) Appl. No.: 18/416,077

(22) Filed: Jan. 18, 2024

(30) Foreign Application Priority Data
Feb. 15, 2023 (JP) 2023-021456

(51) Int. Cl. G06Q 30/0207; G06F 3/14

(52) U.S. Cl. CPC G06Q 30/0222; G06F 3/14

(57) ABSTRACT

The stores include a first store that offers senior discounts for users over a specific age and a second store that does not offer senior discounts. The processor controls the display to display a first coupon image usable at a first store and a second coupon image usable at a second store.

### CROSS-REFERENCE TO RELATED APPLICATION

This application claims priority to Japanese Patent Application No. 2023-021456 filed on Feb. 15, 2023 incorporated herein by reference in its entirety.

### BACKGROUND

### 1. Technical Field

The present disclosure relates to information equipment and a display method.

### 2. Description of Related Art

For improving health, revitalizing economy, etc., it is desired to encourage seniors to go out. As a system to improve convenience when going out, for example, Japanese Unexamined Patent Application Publication No. 2012-225939 (JP 2012-225939 A) discloses a rest place guidance system that guides a user to a rest place decided according to the mobility ability of the user that varies depending on the age etc., as well as a recommended route from the departure point to the destination.

### SUMMARY

However, in the above rest place guidance system, there is no disclosure or suggestion of a method for promoting the improvement of health of seniors by invigorating outing activities of seniors. In particular, in order to improve health of seniors and to revitalize economy, it is desirable to promote attracting customers to stores offering preferential treatment to seniors.

The present disclosure has been made in order to solve the above problem, and an object of the present disclosure is to provide information equipment and a display method that can promote invigoration of the activities of seniors, improvement of health of seniors, and revitalization of economy.

(1) Information equipment according to a first aspect of the present disclosure includes a display and a control device. The display is configured to display a coupon image that is able to be used at a store. The control device controls the display. The store includes a first store that offers a senior discount for a user at a specific age or over, and a second store that does not offer the senior discount. The control device controls the display so as to display a first coupon image that is able to be used at the first store and to display a second coupon image that is able to be used at the second store.

(2) A senior mark image indicating that a store offers the senior discount is added to the first coupon image.

In the above configurations (1) and (2), the coupon that is able to be used at the store offering the senior discount is displayed. Therefore, the motivation of the senior to visit the store and purchase a product or a service increases, and at the same time, the ability of the store to attract senior customers improves. Accordingly, it is possible to promote invigoration of the activities of seniors, improvement of health of seniors, and revitalization of economy.

(3) The control device controls the display so as to display the first coupon image in a first mode and to display the second coupon image in a second mode. The first mode is a mode that is more emphasized than the second mode.

According to the above configuration (3), the coupon for the store offering the senior discount is able to be easily understood, and the ability to attract senior customers can be further improved.

(4) The control device controls the display so as to display position information of an automated external defibrillator (AED) disposed around the first store.

According to the above configuration (4), the senior is able to go out with peace of mind, and the ability to attract senior customers can be further improved.

(5) A display method according to a second aspect of the present disclosure is a display method of a coupon image that is able to be used at a store. The display method includes a display step of displaying the coupon image on a display of information equipment. The store includes a first store that offers a senior discount for a user at a specific age or over, and a second store that does not offer the senior discount. The display step includes a step of displaying a first coupon image that is able to be used at the first store and displaying a second coupon image that is able to be used at the second store.

According to the above method (5), similarly to the above configuration (1), it is possible to promote invigoration of the activities of seniors, improvement of health of seniors, and revitalization of economy.

According to the present disclosure, it is possible to promote invigoration of the activities of seniors, improvement of health of seniors, and revitalization of economy.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing the overall configuration of a management system according to an embodiment of the present disclosure;

FIG. 2 is a diagram showing an example of the configuration of a server, a terminal, etc.;

FIG. 3 is a diagram showing an example of a display mode of a terminal;

FIG. 4 is a diagram showing an example of a display mode of a terminal display;

FIG. 5 is a flowchart showing an example of the processing procedure of display processing according to the present embodiment; and

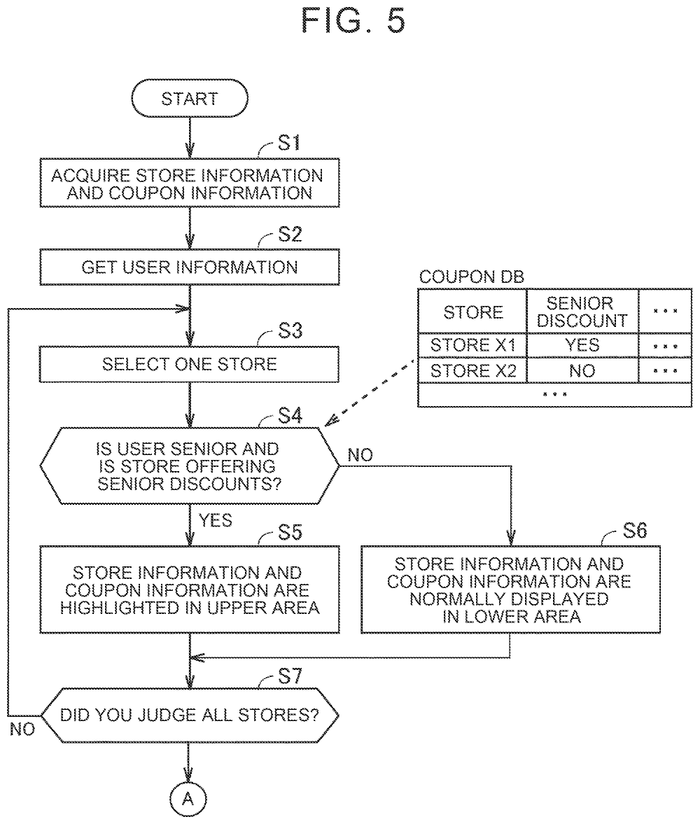

FIG. 6 is a flowchart showing an example of the processing procedure of display processing according to the present embodiment.

### DETAILED DESCRIPTION OF EMBODIMENTS

Hereinafter, embodiments of the present disclosure will be described in detail with reference to the drawings. In the drawings, the same or corresponding portions are denoted by the same reference signs and the description thereof will not be repeated.

### System Configuration

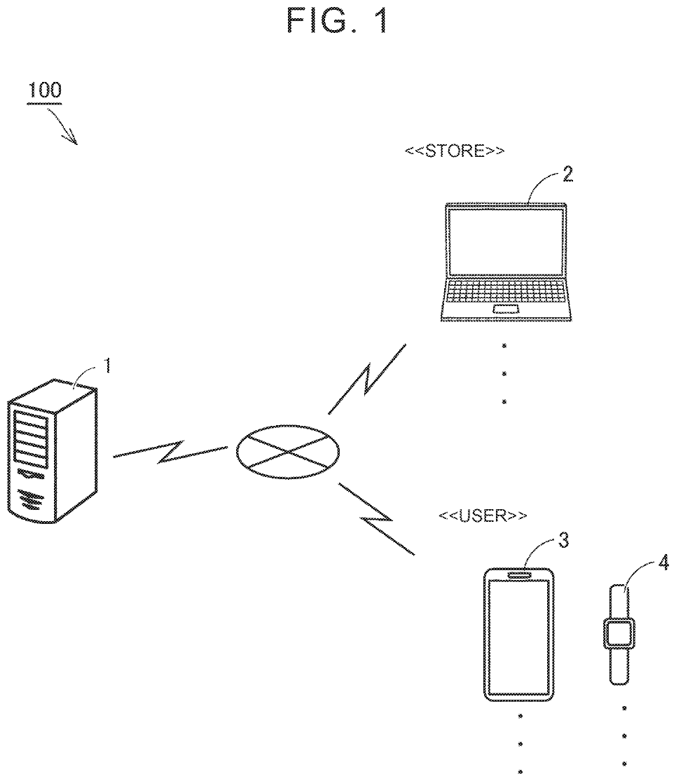

FIG. 1 is a diagram schematically showing the overall configuration of a management system 100 according to an embodiment of the present disclosure. The management system 100 includes a server 1, multiple terminals 2, multiple terminals 3, and multiple smart watches 4. The management system 100 is a system that manages the provision of coupons by a plurality of stores.

The terminal 2 is a terminal used by each of a plurality of stores that offer discounts using coupons. The terminal 3 is a terminal carried by each of a plurality of users who use these stores. Each user may carry a smart watch 4 along with a terminal 3. The terminal 3 corresponds to an example of the “information equipment” of the present disclosure.

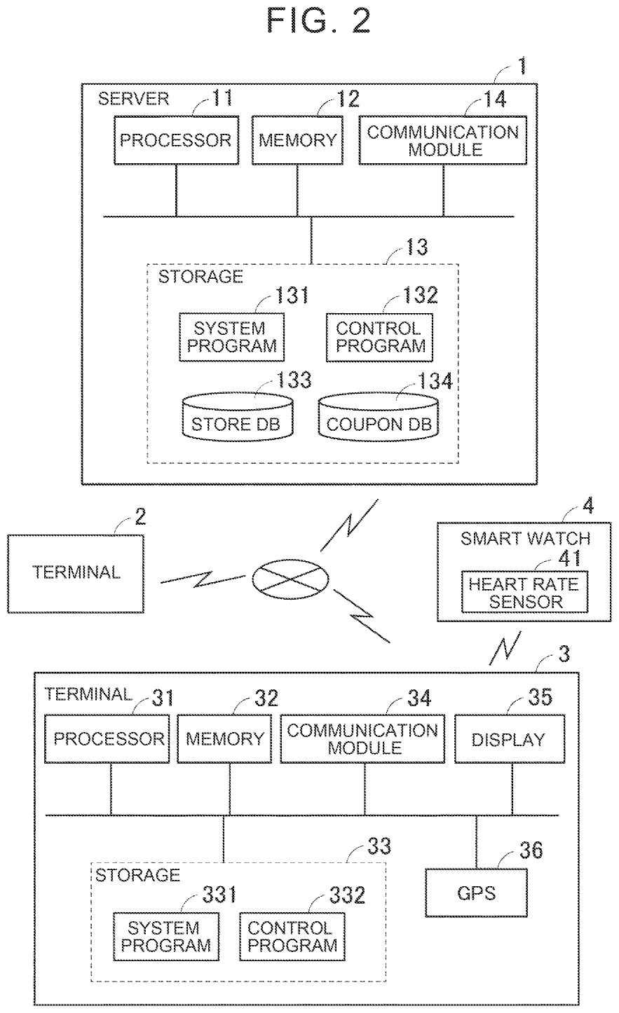

FIG. 2 is a diagram showing an example of the configuration of the server 1, the terminal 3, etc. Server 1 includes, for example, processor 11, memory 12, storage 13 and communication module 14.

The processor 11 is, for example, a microprocessor such as a Central Processing Unit (CPU) or Micro-Processing Unit (MPU). Memory 12 is a volatile memory such as Random Access Memory (RAM). The processor 11 implements various processes by reading out the system program 131 and the control program 132, developing them in the memory 12, and executing them.

The storage 13 is a rewritable nonvolatile memory such as a Hard Disk Drive (HDD), Solid State Drive (SSD), or flash memory. The storage 13 includes a system program 131 including an Operating System (OS), a control program 132 including computer-readable codes necessary for control calculations, a store database (DB) 133, and a coupon database (DB) 134. Stored.

The store DB 133 records information about each store. For example, the store type, store location, store introduction text, store introduction image, etc. The type of store indicates a type of business or a further subdivided category, such as a restaurant, a store, a rental car, and the like. Furthermore, the restaurant may be subdivided into categories such as Japanese cuisine and Western cuisine.

The coupon DB 134 records information on coupons that can be used at each store. The coupon information includes, for example, the discount amount or discount rate for food and drink at a restaurant, and the period during which the coupon can be used. Additionally, the coupon DB 134 records whether there is a senior discount, which will be described later.

Communication module 14 includes a communication interface with a network such as the Internet. The communication module 14 is configured to allow two-way communication with external devices of the server 1 (a plurality of terminals 2, a plurality of terminals 3, etc.).

The terminal 3 used by the user using the store is, for example, a smartphone or a tablet. Terminal 3 may be a laptop personal computer (PC). The terminal 3 includes, for example, a processor 31, a memory 32, a storage 33, a communication module 34, a display 35, and a Global Positioning System (GPS) 36.

Processor 31 is, for example, a microprocessor such as a CPU or MPU. The memory 32 is a volatile memory such as RAM. The processor 31 implements various processes by reading out the system program 331 and the control program 332, developing them in the memory 32, and executing them. The processor 31 corresponds to an example of the “control device” of the present disclosure. Note that the processor 31 may include the memory 32 and the like to form a control device.

The storage 33 is a rewritable non-volatile memory such as flash memory. The storage 33 stores a system program 331 including an OS and a control program 332 including computer-readable code required for control calculations.

Communication module 34 includes a communication interface conforming to wireless communication standards. The wireless communication standard may be Long Term Evolution (LTE) such as 4G, 5G, or a wireless Local Area Network (LAN) such as Wireless Fidelity (Wi-Fi), or both. There may be. The communication module 34 is configured to be able to communicate bidirectionally with the server 1 and the smart watch 4.

The display 35 is a mobile display such as organic Electro Luminescence (EL) or liquid crystal. The display 35 is configured to display various information according to control commands from the processor 31. In this example, the display 35 is a display with a touch panel capable of accepting user input operations.

The GPS 36 acquires information (GPS information) indicating the current position of the terminal 3 based on signals from a plurality of satellites, and outputs the GPS information to the processor 31. Note that terminal 3 may include a beacon receiver (not shown) instead of or in addition to GPS 36.

A control program 332 (application software) for displaying coupon information is installed in the terminal 3. The user can display coupon information by operating the terminal 3.

The terminal 2 used by the store is, for example, a laptop PC, but may also be a tablet, a smart phone, or the like. Although not shown, terminal 2 also includes a processor, memory, storage, communication module and display. This processor implements various processes by expanding the program memory stored in the storage and executing the program. This communication module is configured to allow two-way communication with the server 1. Each store can access the server 1 from the terminal 2 and update information in the store DB 133 and the coupon DB 134.

The smart watch 4 is a smart watch worn by a user who uses the terminal 3. Although not shown, like the terminal 3, the smart watch 4 also includes a processor, memory, storage, communication module, and display. This processor implements various processes by expanding the program memory stored in the storage and executing the program. This communication module is configured to be capable of bidirectional communication with the terminal 3 used by the user.

Furthermore, the smart watch 4 includes an optical heart rate sensor 41. Heart rate sensor 41 measures the user's heart rate. Information on the measured heart rate is transmitted to the terminal 3. The terminal 3 determines the user's health condition based on the heart rate using dedicated application software installed in the terminal 3 in advance.

For example, when the terminal 3 detects that the heart rate continues to exceed a predetermined value, that the heart rate continues to fall below a predetermined value, or an irregular heartbeat, the terminal 3 detects “abnormal heartbeat” as an abnormality related to the user's health condition. The terminal 3 is configured to be able to transmit abnormality information to the server 1 when an abnormality related to the user's health condition is detected.

### Display of Coupon Information Etc.

3 and 4 are diagrams showing an example of the display mode of the display 35 of the terminal 3. Coupon information and the like can be displayed on the display 35 by a user operation on the terminal 3. The user can set search conditions or click on the displayed link to display coupon information and the like.

For example, assume that the user searches for store information by setting “city B, prefecture A” and “Restaurant” as search conditions. The server 1 extracts, from the store DB 133 and the coupon DB 134, stores whose store type is “restaurant” and store location is “city B, prefecture A” and where coupon information is registered. Note that it may also be a display of recommended stores or services in the area.

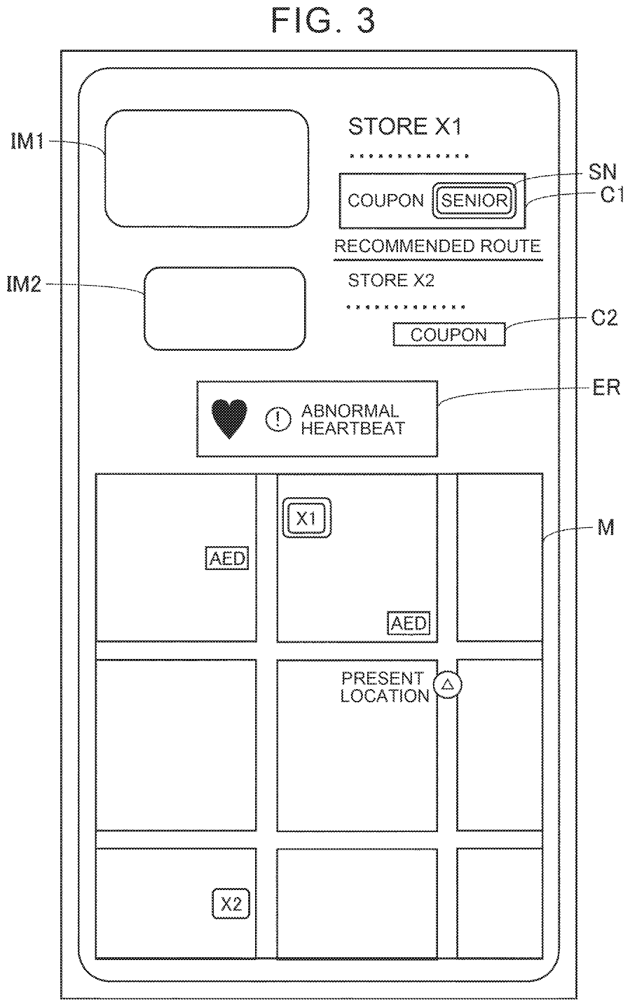

As shown in FIG. 3, it is assumed that stores X1 and X2 are extracted as a group of stores that match the search conditions (hereinafter referred to as a “matching store group”) through this search. The types of stores X1 and X2 are both “restaurants”, and the locations of both stores are “city B, prefecture A”.

Here, the stores registered in the store DB 133 include a first store that offers a senior discount for users over a specific age (hereinafter also referred to as a “senior discount store”) and a second store that does not offer a senior discount (hereinafter also referred to as a “regular store”).

The “specific age” is an arbitrarily set age, for example, 50 years old, 55 years old, 60 years old, 65 years old, etc. When 60 years old is set as the “specific age”, users aged 60 years or older are recognized as “seniors”, and senior discounts can be given to users aged 60 years or older at senior discount stores. The specific age may be set in a setting file recorded on the server 1, or may be set for each coupon.

The user's age is set in advance in the application software for displaying coupon information. The server 1 determines whether the user is a senior based on the set age of the user.

The coupons include a first coupon that can be used at senior discount stores (hereinafter also referred to as “senior discount store coupon”) and a second coupon that can be used at regular stores (hereinafter also referred to as “regular store coupon”).

The terminal 3 can display a senior discount store coupon image or a regular store coupon image. The user can present these coupon images to a store and receive a discount using the coupon.

The terminal 3 displays the regular store coupon image in a second mode (hereinafter also referred to as “normal mode”), and displays the senior discount store coupon image in a first mode (hereinafter also referred to as “emphasis mode”) that emphasizes the senior discount store coupon image more than the normal mode. For example, the terminal 3 may display the senior discount store coupon image in an emphasized manner by displaying the senior discount store coupon image larger than the regular store coupon image. Store information other than the coupon image may be displayed in a larger size.

Alternatively, the terminal 3 may display the senior discount store coupon image in an emphasized manner by displaying the senior discount store coupon image above the regular store coupon image. Alternatively, the terminal 3 may emphasize and display the senior discount store coupon image by adding and displaying the senior mark image SN indicating that the store is offering senior discounts to the senior discount store coupon image.

In this way, seniors will be more motivated to visit the senior discount store and purchase products or services, and the ability to attract seniors to the senior discount store will be improved. Accordingly, it is possible to promote invigoration of the activities of seniors, improvement of health of seniors, and revitalization of economy.

Here, it is assumed that the store X1 extracted above is a senior discount store that offers a senior discount, and the store X2 is a regular store that does not offer a senior discount. As shown in FIG. 3, information about store X1, which is a senior discount store, is displayed at the top of the screen, while information about store X2, which is a regular store, is displayed at the bottom of the screen.

Information on store X1 including the coupon image is displayed in a large size, while information on store X2 is displayed smaller than information on store X1. While the senior mark image SN is added to and displayed on the coupon image of store X1, this is not displayed on the coupon image of store X2.

On the screen, the store name “Store X1” is displayed in large letters as information about the store X1, and an image IM1 is displayed in a large size as an introduction image of the store X1. Below the name of the store, an introductory text of the store and a coupon image C1 are displayed in a large size. Furthermore, a senior mark image SN is added to the coupon image C1.

Information on the store X2 is displayed below the information on the store X1. As the store X2, the store name “store X2”, the image IM2 as the introductory image of the store X2, the introductory text of the store X2 and the coupon image C2 are displayed. Store X2, image IM2, introductory text of store X2, and coupon image C2 are displayed smaller than store X1, image IM1, introductory text of store X1, and coupon image C1, respectively. The senior mark image SN is not added to the coupon image C2.

Furthermore, in this embodiment, the terminal 3 displays position information of Automated External Defibrillators (AEDs) placed around the senior discount store. A map image M is displayed on the screen. Map image M shows position information of store X1 and store X2. Furthermore, the map image M displays positional information of AEDs placed around the store X1, which is a senior discount store.

The position information of the AED may be configured to be displayed when abnormal information regarding the user's health (in this embodiment, abnormal heartbeat information) is acquired. For example, when acquiring heartbeat abnormality information as abnormality information regarding the user's health, the terminal 3 displays positional information of AEDs placed around the user's current position.

When the terminal 3 detects an abnormal heartbeat from the smart watch 4, the terminal 3 displays an abnormality information image ER on the screen of the terminal 3. The abnormality information image ER indicates that an abnormality has occurred in the user's heartbeat. Further, the terminal 3 acquires position information of AEDs placed around the user's current location from the server 1 and displays this. Note that if the user has a companion, the position information of the AED may also be displayed on the terminal 3 of the companion.

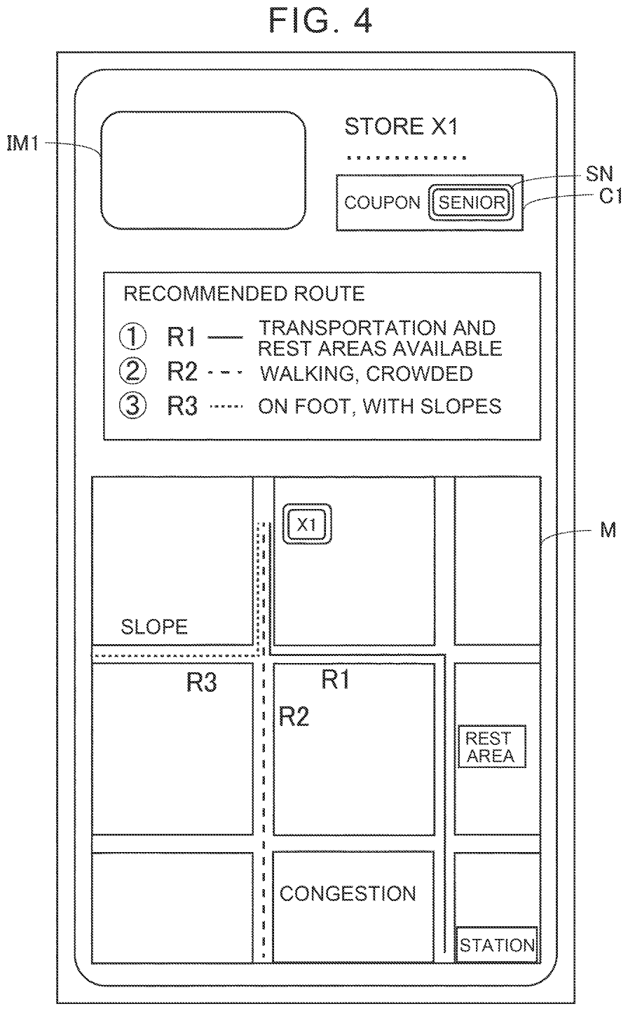

Furthermore, the terminal 3 is configured to be able to display recommended routes to senior discount stores. This will be explained below using FIG. 4. As shown in FIG. 4, information about store X1, which is a senior discount store, is displayed on the screen. On the screen of FIG. 3, by clicking the link to the recommended route displayed together with store X1, the recommended route shown in FIG. 4 is displayed.

Recommended routes R1, R2, and R3 are shown as recommended routes to store X1. The recommended route indicates a route (route) recommended to the user from among a plurality of travel route candidates (referred to as a “route candidate group”) from the user's current location to the senior discount store. Recommended route R1 is the most recommended route, recommended route R2 is the next recommended route after recommended route R1, and recommended route R3 is the next recommended route after recommended route R2.

The server 1 may select a plurality of route candidates using a known technique based on the distance from the current location (user's position information) to the destination (store).

The recommended routes include a first recommended route (in the above example, “recommended route R2 or R3”) and a second recommended route that is more recommended than the first recommended route (in the above example, “recommended route R1”).

In this embodiment, the second recommended route (recommended route R1) includes a higher proportion of rest places than the first recommended route (recommended routes R2, R3). Since the user is a senior, it becomes easier to select a route with a resting place along the way as the recommended route R1, taking into consideration the user's mobility.

Furthermore, the second recommended route (recommended route R1) includes a lower percentage of uphill routes, downhill routes, and congested routes than the first recommended routes (recommended routes R2, R3). Since the user is a senior citizen, it is difficult to select a route that includes uphill slopes, downhill slopes, and crowded roads as the recommended route R1, considering the user's mobility.

In addition, the second recommended route (recommended route R1) includes a route using transportation out of walking routes and routes using transportation than the first recommended route (recommended routes R2 and R3). A high proportion of them are included. Since the user is a senior, it becomes easier to select a route using transportation (train or bus) as the recommended route R1 in consideration of the user's mobility.

In other words, the most-recommended recommended route R1 is more likely to include resting places on the travel route, less likely to include uphill slopes, downhill slopes, and crowded roads, and more likely to include travel by public transportation. As such, the recommended route is determined.

For example, for each route candidate group, “Evaluation value=Travel distance×Coefficient K1+Travel time×Coefficient K2−Number of rest places×Coefficient K3+Number of uphills×Coefficient K4+Number of downhills×Coefficient K5+Number of congested roads×Coefficient K6−Number of times transportation is used×Coefficient K7” is calculated, and the recommended routes R1, R2, and R3 may be determined in the ascending order of the evaluation value.

In the example shown in FIG. 4, the recommended route R1 is set so that the user passes in front of a rest area after leaving the train station. In the recommended route R2, a travel route that involves only walking, including a congested road, is set. In the recommended route R3, a travel route that includes a slope and can only be traveled on foot is set.

### Processing Flow

5 and 6 are flowchart illustrating an example of the processing procedure of display processing according to this embodiment. The processing shown in this flowchart is executed when a user operation is performed to start displaying store and coupon information.

Each step is realized by software processing by the processor 31 of the terminal 3 (hereinafter simply referred to as “terminal 3”), but may be realized by hardware (electric circuit, Large Scale Integration (LSI), etc.) arranged in the processor 31. Hereinafter, the step is abbreviated as S.

For example, it is assumed that the user operates the terminal 3 to set some search conditions and perform an operation to display store and coupon information. At this time, it is assumed that a group of stores matching the search condition (matching store group) has already been extracted. For example, in the example shown in FIG. 4, when the search conditions are “city B, prefecture A” and “restaurant”, “stores X1 and X2” are extracted as a matching store group.

In S1, the terminal 3 acquires store information and coupon information of the matching store group. The terminal 3 acquires the store information of the matching store group recorded in the store DB 133 and the coupon information of the matching store group recorded in the coupon DB 134 through communication with the server 1. In the above example, store information and coupon information for stores X1 and X2 are acquired. In S2, the terminal 3 acquires user information. In the above example, it is specified that the user falls under the category of “senior”.

In S3, the terminal 3 selects one store. For example, in the above example, store X1 is selected from extracted stores X1 and X2.

In S4, the terminal 3 determines whether the user is a senior and the selected store is a store offering a senior discount. For example, the coupon DB 134 records whether a senior discount is applied to each coupon (with/without a “senior discount”).

For example, if a store has at least one coupon to which a senior discount is applied, the store is determined to be a senior discount store. On the other hand, if there is no coupon to which the senior discount is applied to the store, the store is determined to be a regular store. Here, it is assumed that the user is a senior and store X1 is determined to be a senior discount store. On the other hand, it is assumed that store X2 is determined to be a regular store.

If it is determined that the user is a senior and the selected store is a store offering senior discounts (YES in S4), the terminal 3 highlights the store information and coupon information of the selected store in the upper area (S5). As explained using FIG. 3, store information and coupon information for store X1 are highlighted in the upper area. Specifically, store information and coupon information for store X1 are displayed in a large size, and a senior mark image is added to the coupon image.

If the user is a senior and the selected store is not determined to be a senior discount store (NO in S4), the terminal 3 normally displays the store information and coupon information of the selected store in the lower area (S6). When store X2 is selected, store information and coupon information for store X2 are normally displayed in the lower area, as described using FIG. 3.

If the terminal 3 has determined for all stores (YES in S7), it ends this process. On the other hand, if the terminal 3 has not determined for all stores (NO in S7), the process returns to S3. As a result, the processes from S4 to S6 are executed for all the stores in the matched store group. For example, if the matching store group is stores X1 and X2, the processes from S4 to S6 are executed in the order of X1 and X2.

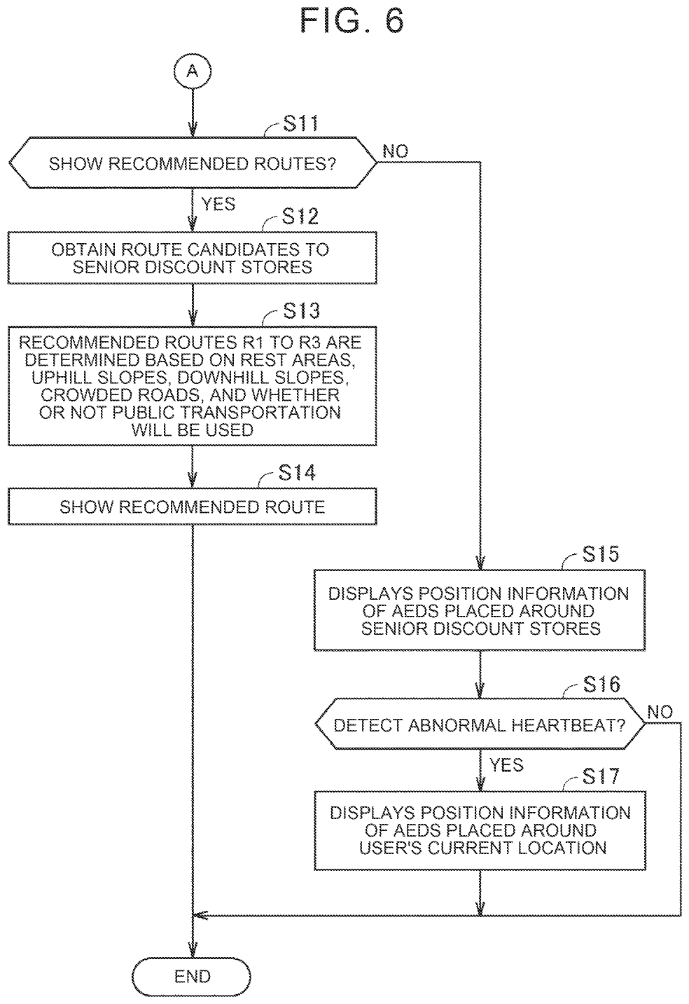

As shown in FIG. 6, when displaying the recommended route (YES in S11: meaning the state in FIG. 4), the terminal 3 acquires a group of route candidates to senior discount stores (S12). In S13, the terminal 3 determines recommended routes R1 to R3 depending on rest areas, uphill slopes, downhill slopes, crowded roads, and whether or not transportation is used. The terminal 3 displays the recommended route in S14 (see FIG. 4), and ends this process. The method for determining the recommended routes R1 to R3 is as explained using FIG. 4.

If the terminal 3 does not display the recommended route (NO in S11:

means the state shown in FIG. 3), the terminal 3 displays position information of AEDs placed around the senior discount store (S15: see FIG. 3). If an abnormality in the user's heartbeat is detected (YES in S16), the terminal 3 displays the position information of AEDs placed around the user's current location (S17: see FIG. 3), and ends this process. If no abnormality in the user's heartbeat is detected (NO in S16), the terminal 3 directly ends this process. The method for detecting an abnormal heartbeat and the method for displaying the AED are as described using FIG. 3.

As explained above, in this embodiment, the store includes a first store (senior discount store) that offers senior discounts for users over a specific age, and a second store that does not offer senior discounts (regular store). The processor 31 controls the display 35 to display a first coupon (senior discount store coupon) image that can be used at a senior discount store and a second coupon (regular store coupon) that can be used at a regular store.

Moreover, a senior mark image SN indicating that the store offers a senior discount is added to the senior discount store coupon image.

In this way, coupons that can be used at senior discount stores that offer senior discounts are displayed, which increases seniors' motivation to visit senior discount stores and purchase products or services. The ability to attract senior customers will improve. Accordingly, it is possible to promote invigoration of the activities of seniors, improvement of health of seniors, and revitalization of economy.

The processor 31 controls the display 35 to display the senior discount store coupon image in an emphasized mode and to display the regular store coupon image in a normal mode. The emphasis mode is a mode that is emphasized more than the normal mode. This makes it easier to understand coupons for stores offering senior discounts, and it is possible to improve the ability of senior discount stores to attract more senior customers.

The processor 31 controls the display 35 to display position information of AEDs placed around the senior discount store. This allows seniors to go out with peace of mind, and also improves the ability to attract seniors to senior discount stores.

The processor 31 controls the display 35 to display the senior discount store coupon image above the regular store coupon images that can be used at regular stores. This improves convenience for seniors, and also improves the ability to attract seniors to senior discount stores.

When the processor 31 acquires abnormality information regarding the user's health, the processor 31 controls the display 35 to display position information of AEDs placed around the user's current position. This allows seniors to go out with peace of mind.

Processor 31 controls display 35 to display the recommended route to the senior discount store. The recommended routes include a first recommended route (recommended routes R2, R3) and a second recommended route (recommended route R1) that is more recommended than the first recommended route. The second recommended route includes a higher proportion of resting places than the first recommended route. This allows even seniors with limited physical strength to go out with peace of mind.

The second recommended route includes a lower percentage of uphill routes, downhill routes, and congested routes than the first recommended route. This allows even seniors with limited physical strength to go out with peace of mind.

The second recommended route includes a higher percentage of routes using transportation among walking routes and routes using transportation than the first recommended route. This allows even seniors with limited physical strength to go out with peace of mind.

In addition, in this embodiment, senior discount store coupons and senior discount store information that can be used at senior discount stores that offer senior discounts are highlighted, and senior discount store coupons that can be used at regular stores that do not offer senior discounts are highlighted. Regular store coupons and regular store information are now displayed normally. However, this is not limited to this, and among the coupons that can be used at senior discount stores that offer senior discounts, only the coupons that offer senior discounts and information about the stores that are displayed at that time are highlighted. Good too. In this case, even if the coupon can be used at a senior discount store, a coupon that does not offer a senior discount is not highlighted. Moreover, an image indicating that a senior discount is to be implemented may be added to the coupon image for implementing a senior discount.

In the present embodiment, the terminal 3 has been described to correspond to an example of the “information equipment” of the present disclosure, but the server 1 and the display are not limited to this, and may correspond to an example of the “information equipment” of the present disclosure. This display may be connected to the server 1 or may be provided in a terminal that communicates with the server 1. In this case, the server 1 generates image information to be displayed on the display.

The embodiments disclosed this time should be considered to be illustrative in all respects and not restrictive. The scope of the present disclosure is indicated by the scope of the claims rather than the description of the above-described embodiments, and is intended to include all modifications within the scope and meaning equivalent to the scope of the claims.

What is claimed is:

1. Information equipment comprising:
a display configured to display a coupon image that is able to be used at a store; and
a control device that controls the display, wherein
the store includes a first store that offers a senior discount for a user at a specific age or over, and a second store that does not offer the senior discount, and
the control device controls the display so as to display a first coupon image that is able to be used at the first store and to display a second coupon image that is able to be used at the second store.

2. The information equipment according to claim 1, wherein a senior mark image indicating that a store offers the senior discount is added to the first coupon image.

3. The information equipment according to claim 1, wherein:
the control device controls the display so as to display the first coupon image in a first mode and to display the second coupon image in a second mode; and
the first mode is a mode that is more emphasized than the second mode.

4. The information equipment according to claim 1, wherein the control device controls the display so as to display position information of an automated external defibrillator (AED) disposed around the first store.

5. A display method of a coupon image that is able to be used at a store, the display method comprising a display step of displaying the coupon image on a display of information equipment, wherein:
the store includes a first store that offers a senior discount for a user at a specific age or over, and a second store that does not offer the senior discount; and
the display step includes a step of displaying a first coupon image that is able to be used at the first store and displaying a second coupon image that is able to be used at the second store.
